(19) United States
(12) Patent Application Publication
(10) Pub. No.: US 2026/0034646 A1
(43) Pub. Date: Feb. 5, 2026

(54) Air Suspension Wrench

(71) Applicant: Nigel Buchanan, Fife (GB)

(72) Inventor: Nigel Buchanan, Fife (GB)

(21) Appl. No.: 18/998,802

(22) PCT Filed: Jul. 28, 2023
(86) PCT No.: PCT/GB2023/052005

§ 371 Date: Jan. 27, 2025

(30) Foreign Application Priority Data
Jul. 28, 2022 (GB) 2211019.1

(51) Int. Cl. B25B 13/52

(52) U.S. Cl. CPC B25B 13/52

(57) ABSTRACT

Air Suspension Wrench Comprises. a recycled cut to length, cam belt (60), held at the fixed end (63) against the spacer plate (50) by locking pins (70) within cam belt cog recesses (62). The cam belt (60) encompasses the workpiece cylindrical surface (81), the cam belt cog protrusions (61) facing outwards. The cam belt free end (64) when engaged, is drawn inwards into the drive unit (20) by the rotation of the drive unit axle (30) having corresponding output drive cog (33) protrusions on its periphery and an input drive recess (32) within its centre, securing the cam belt inner drive surface (65) upon the workpiece (80) until it can tighten no longer, all further drive torque DT used to turn the workpiece. Reversing the drive unit axle (30) allows repositioning. The end plate elongate curved contact surface (407) and extended first and second ends (405, 406) preventing cogling during use and a demountable rotational pin (71). aiding both cam belt (60) fitment and ensuring that at least four cam belt cog protrusions (61) are engaged.

### FIELD OF THE INVENTION

The invention relates to an air suspension wrench or air reservoir wrench, for example for the removal of air springs as used in Citroen, Mercedes, Rolls Royce vehicles, numerous industrial etc. air reservoir cylinders and most oil filter canisters. The invention also relates to strap wrenches.

### BACKGROUND TO THE INVENTION

These cylindrical like vessels can be very difficult to loosen in the initial stages requiring considerable torque to overcome this initial turning resistance. Known types of strap wrenches seldom have enough grip or inherent strength to overcome this problem whilst chain wrenches have the strength for the job but incur surface damage to the worked cylindrical workpiece and sometimes total failure through gouging or crushing.

All references, including patents and patent applications, cited herein are incorporated by reference to the same extent as if each reference were individually and specifically indicated to be incorporated by reference and were set forth in its entirety herein.

Chain wrenches are bulky to the extent that their use in confined spaces is near impossible. US2008047398 provides an oil canister strap wrench using a cogged belt and a cogged drive, however the interaction between the drive unit and cylindrical workpiece has an inherent problem in that the cogged belt fixed end in high torque use can bend the locking pins, crack the belt and strip the cogs from the belt due to its tight bend angle in use, furthermore the drive unit, because of its compact design coupled with smooth radiused ends, can easily rotate against the oil filter or workpiece wall, further damaging the engaged oil filter or workpiece wall. The initial installation of the cogged belt free end around the drive portion output drive cogs also being very problematic as the hard, high friction rubber belt must push between the spacer portion, guide surface and the drive cogs, furthermore said output drive cogs only fully engaging with two of the cogged belt protrusions which can lead to premature failure. US 2011/0167964 illustrates the use of a continuous looped cogged belt and drive portion having drive cogs in order to provide a ratcheting function after the cogged belt is tightened.

It is an object of the present invention to provide an uncomplicated, high strength tool that can be usefully used to provide an air suspension wrench, useable with negligible damage to the workpiece cylindrical surface, whilst being simple and less expensive to manufacture, furthermore specifically designed to use, as its main part, a normally discarded to landfill, now recycled, used vehicle camshaft or serpentine belt which is replaced as a vehicle service item. It is a further object of the present invention to at least partially alleviate the above-mentioned disadvantages, or at least to provide an alternative to existing products.

### SUMMARY OF THE INVENTION

The present invention provides an air suspension wrench for the application of a turning force to such an object as air springs as used in Citroen, Mercedes, Rolls Royce vehicles, numerous industrial etc. air reservoir cylinders and the like and most vehicle oil filter canisters, hereinafter termed a workpiece, in order to remove or install the workpiece at high torque if required with minimal chance of surface damage to said workpiece.

Characterised by the incorporation of an, in best practice, used and now recycled vehicle camshaft or serpentine belt hereinafter termed the cam belt which is normally a throw away vehicle service item, cut to length for the particular purpose required, said cam belt comprising a free end and a retained end, fitted within the drive unit, said cam belts normally utilizing a standardised ten millimetres cog pitch.

Said drive unit further comprising a drive axle with output drive cog protrusions on its periphery and an input drive recess within its centre, with trunnions either end incorporating circlip grooves for retaining circlips. Said trunnions rotationally held within end plate axle bushes, said end plates further retained in position by a spacer plate having distancing shoulders and riveting portions, further creating a restricted passage through which the cam belt free end can pass, when its incorporated cam belt cogs are fully engaged within said output drive cogs, whereas the cam belt inner drive surface is capable of traversing against the spacer plate guide surface, said drive unit is further characterized by the fitment of a rotational pin that is straightforwardly removable in order to easily fit the cam belt free end and after fitment of said rotational pin ensure that at least four of the cam belt cog protrusions within the cam belt free end, are now comprehensively engaged into the corresponding drive axle cog recesses in order to distribute the applied drive torque over twice as many cam belt cogs as in the prior art, considerably reducing the incidence of wear or failure.

Said cam belt retained end, cam belt inner drive surface being held as required between the spacer plate guide back surface and a minimum of two known clevis pin type, locking pins engaged within the cam belt cog recesses, said locking pins retained by known R clips or the like. The drive unit is even further characterized by a rotational pin, when installed in the end plates cam belt free end rotational pin bores, which furthermore guides the cam belt free end around the drive axle output drive cogs, therefore forming a cam belt closed loop, with the closed loop internal surface comprising of the cam belt inner drive surface. The rotational pin retained by known R clips or the like, is capable of free rotation within said end plate cam belt free end rotational pin bores as the traversing action of the cam belt inner drive surface propels it round.

In use, when the cam belt is fitted around the generally cylindrical surface of the workpiece and a known corresponding socket drive spigot is engaged into the drive axle input drive recess and operated in the chosen torque direction, said cam belt is pulled through the drive unit restricted passage in order to tighten said closed loop internal surface upon the cylindrical surface of the workpiece. When sufficiently tight upon said generally cylindrical surface of the workpiece any further torque applied to the socket drive spigot, hereinafter designated as a known drive, in the torque direction is now transferred to turn the workpiece in the chosen drive direction, whilst the greater the torque required to turn the said workpiece the greater the tightening action also applied to the workpiece cylindrical surface therefore ensuring maximum grip during the procedure whilst minimising the chance of surface or even catastrophic damage to the workpiece cylindrical surface;

Said end plates even further characterized by preventing whilst in use, said drive unit problematically swivelling inwards in the direction of the known drive, which can create undue tight flexing of the cam belt and or damage to the operated workpiece, by the present incorporation of an extended, end plate first and second ends, within an elongate end plate curved contact surface which in best practice further incorporates end plate gripping teeth, or alternately no end plate gripping teeth, but a U shaped rubber or similar gripping strip held between the end plate curved contact surface end stops;

The end plates second end is even further characterized by now retaining in use the cam belt fixed end generally parallel to the spacer plate guide back surface therefore ensuring said cam belt fixed end is kept generally straight as it is drawn off the workpiece cylindrical surface by the end plates second end's extended profile, therefore drastically reducing unwanted component stress and the chance of locking pin or cam belt failure.

### BRIEF DESCRIPTION OF THE DRAWINGS

A full and enabling disclosure of the present invention including the best mode thereof, directed to one of ordinary skill in the art, is set forth in the specification, which makes reference to the appended drawings, in which:

FIG. 1 Is a perspective view of the air suspension wrench applied for example to an oil filter canister as a workpiece.

FIG. 2 Is a perspective view of the air suspension wrench drive unit.

FIG. 3 Is a perspective view of the drive unit and cam belt disassembled for display purposes.

FIG. 4 Is a top view of the air suspension wrench drive unit and cam belt the top end plate removed (not shown) in order to illustrate the assembly configuration.

FIG. 5 Is a perspective view of the air suspension wrench applied for example to an oil filter canister as a workpiece. The drive unit being driven by a known drive.

### A MARSHALLING OF REFERENCE NUMERALS UTILISED IN THE DRAWINGS

Following is a listing of the various components used in the best mode preferred embodiment and alternative embodiments. For the ready reference of the reader the reference numerals have been arranged in ascending numerical order.

| | | | |
|---|---|---|---|
| 1 | Air Suspension Wrench | 50 | Spacer Plate |
| | | 51 | Spacer Plate Guide Surface |
| 20 | Drive Unit | 52 | Spacer Plate Guide Back Surface |
| 21 | Drive Unit restricted Passage | 53 | Spacer Plate Distancing Shoulder |
| | | 54 | Spacer Plate Riveting Portion |
| 30 | Drive Unit Axle | | |
| 31 | Drive Axle Trunnions | 60 | Cam Belt |
| 32 | Drive Axle Input Drive Recess | 61 | Cam Belt Cog Protrusions |
| 33 | Drive Axle Output Drive Cogs | 62 | Cam Belt Cog Recesses |
| 34 | Drive Axle Cog Recesses | 63 | Cam Belt Fixed End |
| 35 | Drive Axle Circlip Groove | 64 | Cam Belt Free End |
| 36 | Drive Axle Circlip | 65 | Cam Belt Inner Drive Surface |
| | | 66 | Cam Belt Closed Loop |
| | | 67 | Cam Belt Cog Pitch |
| 400 | End Plates | | |
| 401 | End Plate Axle Bush | 70 | Locking Pin |
| 402 | End Plate Locking Pin Holes | 71 | Rotational Pin |
| 403 | End Plate Spacer Plate Recess | 72 | R clip |
| 404 | End Plate First End | | |
| 405 | End Plate Second End | 80 | Workpiece |
| 406 | End Plate Gripping Teeth | 81 | Workpiece Cylindrical Surface |
| 407 | End Plate Elongate Curved Contact | | |
| | Surface | | |
| 408 | End Plate Cam Belt Free End | 90 | Known Drive |
| | Rotational Pin Bore | | |
| 409 | End Plate Curved Contact Surface End | D | Drive Direction |
| | Stops | | |
| 410 | End Plate Curved Contact Surface Grip | R | Reverse Direction |
| | Strip | | |
| | | DT | Drive Torque |

### DETAILED DESCRIPTION

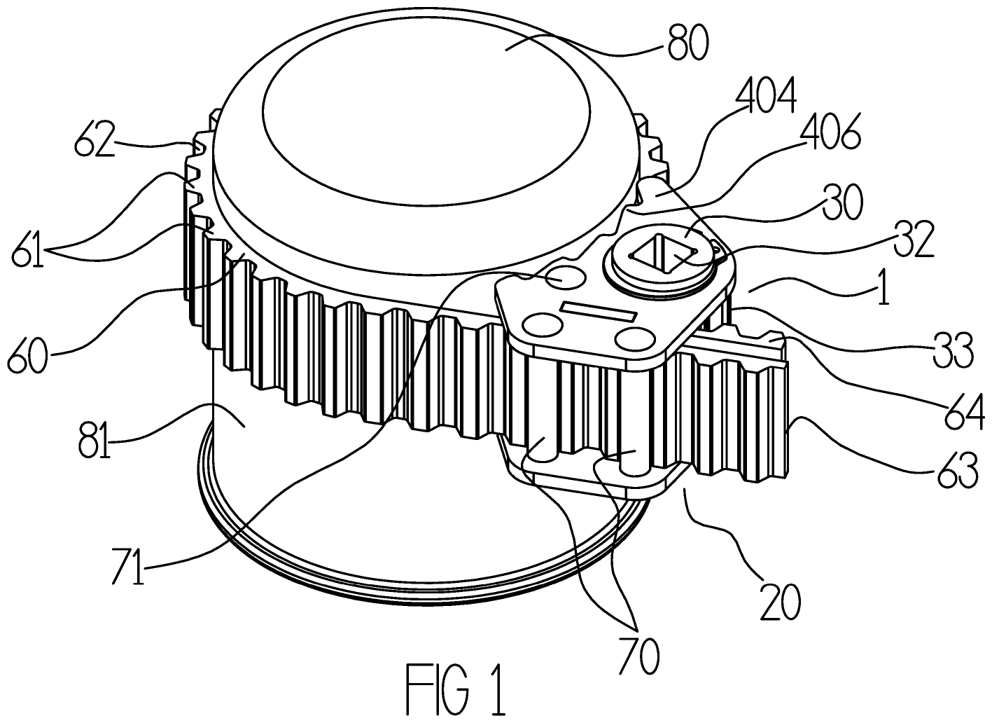

Referring to the drawings as shown in FIGS. 1 to 5 illustrates an air suspension wrench 1 for the application of a turning force in the drive direction D to a workpiece 80, in order to remove or install a workpiece 80 requiring high drive torque DT with minimal chance of damage to said workpiece cylindrical surface 81;

Comprising, a drive unit 20 which further comprises a drive unit axle 30 with drive axle output drive cog 33 protrusions on its periphery and an input drive recess 32 within its centre, with trunnions 31 either end and incorporating circlip grooves 35 for retaining circlips 36 or the like. Said drive axle trunnions 31 rotationally held within end plate axle bushes 401, the end plates 400 further retained in position by a spacer plate 50 having distancing shoulders 53 and secured by riveting portions 54 within end plate spacer plate recesses 403, further creating the drive unit restricted passage 21 through which the cam belt free end 64 can pass when its incorporated cam belt cog protrusions 61 are fully engaged within the drive axle output drive cogs 33, whereas the cam belt inner drive surface 65 is capable of traversing against the spacer plate guide surface 51, further characterized by the fitment of a rotational pin 71 that is straightforwardly removable in order to effortlessly fit the cam belt free end 64 and after fitment of said rotational pin 71 this ensures that now at least four of the cam belt free end 64, cam belt cog protrusions 61 are now comprehensively engaged into the corresponding drive axle cog recesses 34 in order to distribute the applied drive torque DT over twice as many cam belt cogs protrusions 61 as in the prior art, considerably reducing the incidence of wear or failure;

The cam belt fixed end 63, cam belt inner drive surface 65 being held as required between the spacer plate guide back surface 52 and a minimum of two known clevis pin type, locking pins 70 engaged within the cam belt cog recesses 62, said locking pins 70 retained within the end plate locking pin holes 402 by known R clips 72 or the like. The drive unit 20 is further characterized by a rotational pin 71, which when installed within the end plates cam belt free end rotational pin bores 408, furthermore helps guide the cam belt free end 64 around the drive axle output drive cogs 33. Therefore, forming a cam belt 60 closed loop 66, said closed loop 66 internal surface comprising the cam belt inner drive surface 65. The rotational pin 71 retained by known R clips 72 or the like, is capable of free rotation within said end plate cam belt free end rotational pin bores 408 as the action of the cam belt inner drive surface 65 traversing, propels it around;

In use when the cam belt 60 is fitted around the workpiece cylindrical surface 81 and a known drive 90 is engaged into the drive axle input drive recess 32 and operated in the chosen drive direction D, said cam belt 60 is pulled through the drive unit restricted passage 21 in order to tighten the cam belt 60 closed loop 66 inner drive surface 65 upon the workpiece cylindrical surface 81. When sufficiently tight upon said workpiece cylindrical surface 81 any further drive torque DT applied to the known drive 90 in the drive direction D is now transferred to turn the workpiece 80 in the chosen drive direction D, whilst the greater the drive torque DT required to turn the said workpiece 80, the greater the tightening action also applied to the said workpiece cylindrical surface 81 therefore ensuring maximum grip during the procedure whilst minimising the chance of surface or even catastrophic damage to the workpiece cylindrical surface 81. When the known drive 90 and therefore the drive unit axle 30 is operated in the reverse direction R the cam belts 60 grip upon the workpiece cylindrical surface 81 is undone, allowing the drive unit 20 to be appropriately repositioned as required upon said workpiece cylindrical surface 81;

Said end plates 400 further characterized by preventing in use said drive unit 20 problematically swivelling inwards in the direction of the known drive 90, creating undue tight flexing of the cam belt 60 and or damage to the operated workpiece 80, by the incorporation of an extended, end plate first end 404, within the further end plate elongate curved contact surface 407 which in best practice further incorporates end plate gripping teeth 406, or alternately no end plate gripping teeth 406, but a U shaped rubber or similar, end plate curved contact gripping strip 410 held between the end plate curved contact surface end stops 409 within the end plate first end and second end 404, 405, further minimising the chance of surface or even catastrophic damage to the workpiece cylindrical surface 81;

The air suspension wrench 1 is further characterized by ensuring in use the cam belt fixed end 63 is kept generally parallel to the spacer plate guide back surface 52 and further ensuring said cam belt fixed end 63 is kept generally straight as it is drawn off the workpiece cylindrical surface 81 by the extension and correct orientation of the end plates second end 405, therefore drastically reducing unwanted component stress and the chance of locking pin 70 or cam belt 60 failure.

FIG. 1 in particular illustrates the air suspension wrench 1 applied for example to an oil filter canister as a workpiece 80.

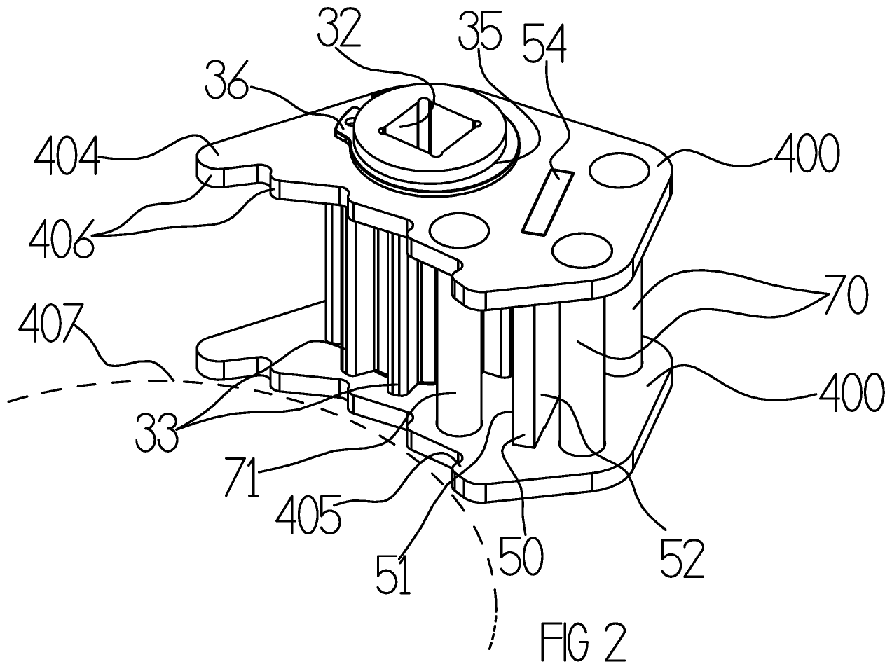

FIG. 2 In particular displays the air suspension wrench 1 drive unit 20.

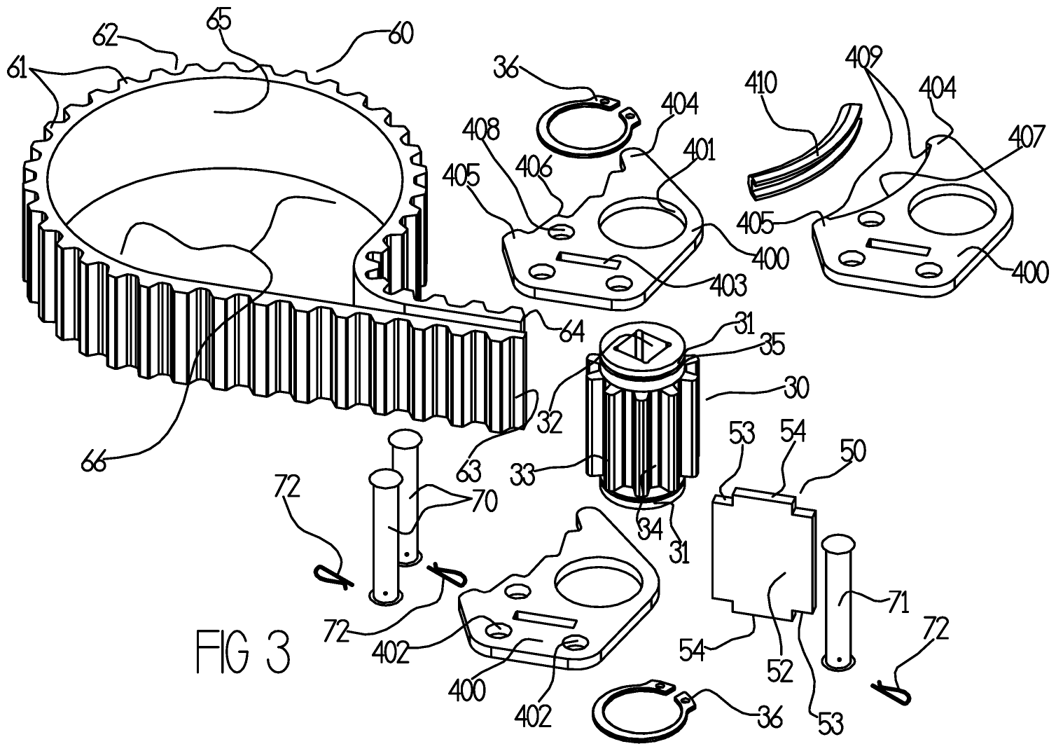

FIG. 3 In particular shows the drive unit 20 disassembled for display purposes, a further end plate 400 with end plate curved contact surface end stops 409 and grip strip 410 shown. A cam belt 60 is also displayed positioned in a cam belt closed loop 66.

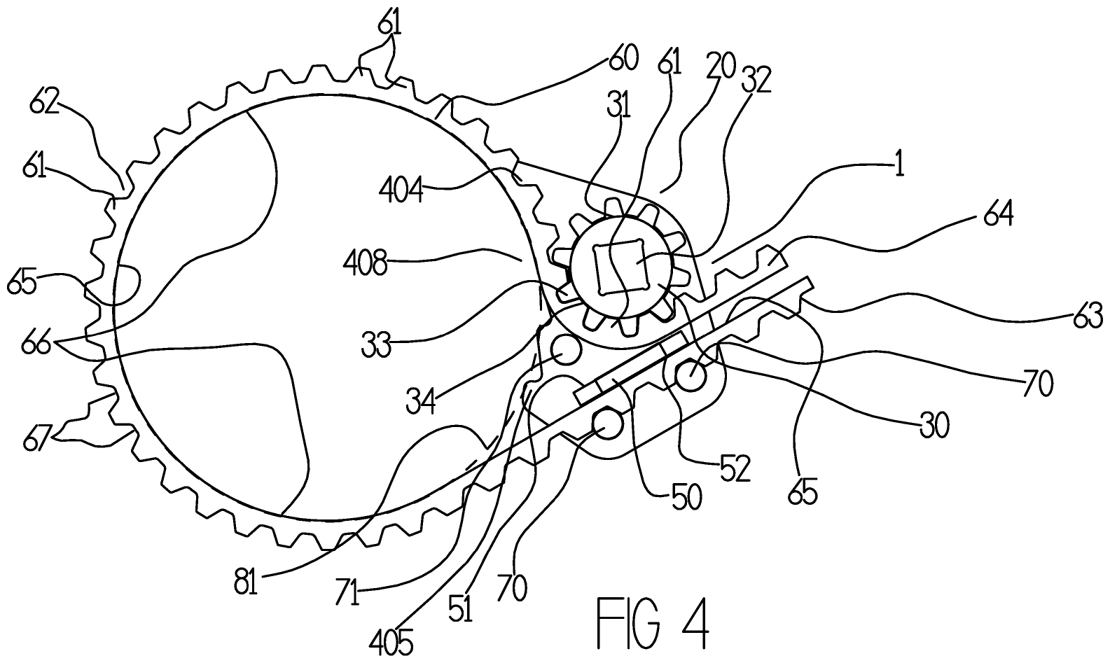

FIG. 4 In particular is a top view of the air suspension wrench 1 drive unit 20 and cam belt 60, the top end plate 400 removed (not shown) in order to illustrate the cam belt 60, cam belt cog pitch 67 and cam belt closed loop 66 configuration. The end plates second end 405 ensuring in use the cam belt fixed end 63 is kept generally parallel to the spacer plate guide back surface 52 and further ensuring the cam belt fixed end 63 is kept generally straight as it is drawn off the workpiece cylindrical surface 81.

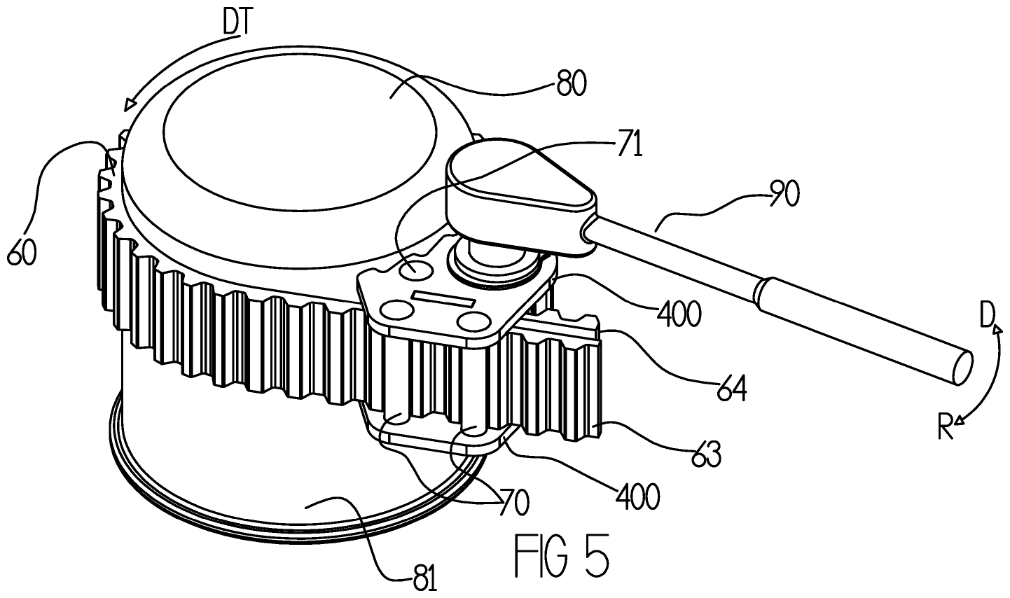

FIG. 5 In particular illustrates the air suspension wrench 1 applied for this example to an oil filter canister as a workpiece 80. The drive unit 20 being driven by a known (socket) drive 90, as displayed in this illustration, the drive unit 20 can be operated in the drive torque DT direction in order to tighten upon then loosen or remove the workpiece 80 in the drive direction D or alternately to reposition the drive unit 20 in the reverse direction R. Thus, embodiments of the invention provide a strap wrench 1 comprising a drive unit 20 and a toothed band, or strap, 60 having a toothed side and an oppositely facing non-toothed side. The drive unit 20 comprises a drive wheel mounting 400 and a toothed drive wheel 30 mounted on the drive wheel mounting so as to be rotatable with respect to the drive wheel mounting. The toothed drive wheel 30 comprises a drive receiving element 32 configured to be engaged by an input driver 90 (for example a wrench as shown in FIG. 5) by which a user can rotate the toothed drive wheel relative to said drive wheel mounting 400. The toothed band has a fixed portion that is fixed to drive wheel mounting 63 and extends from the fixed portion to a free end 64. Between the fixed portion 63 and the free end 64 the toothed band 60 is bent to form a loop 66 having a first end adjoining the fixed portion 63. The non-toothed side forms an inner periphery 65 of the loop 66 for gripping a workpiece within a workpiece receiving space defined by the loop. The loop has a second end and between the second end and the free end 64 the toothed band 60 has an engaging portion at which the toothed surface engages the toothed drive wheel 30. The engaging portion of the toothed band 60 passes between a guide member 71 mounted to the drive wheel mounting 400 and configured such that at least four teeth of said toothed band are in engagement with said toothed drive wheel. The guide member 71 has a curved surface that bears against the toothed band 60 and may be a rod. The guide member 71 may be removably mounted to the drive wheel mounting 400.

The drive receiving element may comprise a drive spigot provided on an end of the toothed drive wheel 30 or an axially extending recess 32 provided in an end of the toothed drive wheel.

In the illustrated example, the drive wheel mounting may comprise a first mounting plate 400 and a second mounting plate 400 disposed opposite and spaced apart from the first mounting plate and the toothed drive wheel 30 extends between the first and second mounting plates. The toothed drive wheel 30 rotatably engages in respective recesses or apertures provided in the first and second mounting plates 400. As best seen in FIG. 3, the toothed drive wheel 30 has a first end provided with a first trunnion 31 that engages in an aperture 401 (optionally instead a recess) in the first mounting plate 400 and a second end provided with a second trunnion 31 that engages in an aperture (optionally instead a recess) in the second mounting plate 400.

With reference to FIGS. 3 and 3, the engaging portion of the toothed band 60 is disposed between the first and second mounting plates 400 and the first and second mounting plates have respective arcuate edges that face towards the workpiece receiving space defined by the loop 66. The arcuate edges are preferably on a radius corresponding at least substantially to the inner diameter of the loop. The arcuate may be configured to define a plurality of teeth 406 to engage a workpiece gripped in the workpiece receiving space. Alternatively, the arcuate edges may be fitted with respective polymer grip enhancing strips 410.

The fixed portion 63 of the toothed band 60 is disposed between a first anchor member 70 and a second member 70 and at least one third anchor member 50. The first and second anchor members 70 engage the toothed side of the toothed band 60 and the at least one third member engages the non-toothed side such that the fixed portion 63 is fixed between said first, second and third anchor portions 50, 70.

It will be understood that each of the elements described above, or two or more together, may also find a useful application in other types of constructions differing from the types above. Whilst the invention has been illustrated and described as embodiments of an air suspension wrench 1 type tool, accordingly it is not limited to the details shown, since it will be understood that various omissions, modifications, substitutions and changes in the forms and details of the device illustrated and its operation can be made by those skilled in the art without departing in any way from the spirit of the invention.

All methods described herein can be performed in any suitable order unless indicated herein or otherwise clearly contradicted by context. The use of any and all examples, or exemplary language (e.g. “In best practice”) provided herein, is merely to better illuminate the invention and does not pose a limitation on the scope of the invention unless otherwise claimed. No language in the specification should be construed as indicating any non-claimed element as essential to the invention.

1. A strap wrench comprising:
a drive unit; and
a toothed band having a toothed side and an oppositely facing non-toothed side,
wherein the drive unit comprises a drive wheel mounting and a toothed drive wheel mounted on said drive wheel mounting so as to be rotatable with respect to the drive wheel mounting,
wherein said toothed drive wheel comprises a drive receiving element configured to be engaged by an input driver by which a user can rotate said toothed drive wheel relative to said drive wheel mounting,
wherein said toothed band has a fixed portion that is fixed to said drive wheel mounting and extends from said fixed portion to a free end,
wherein between said fixed portion and said free end said toothed band is bent to form a loop having a first end portion adjoining said fixed portion,
wherein said non-toothed side forms an inner periphery of said loop for gripping a workpiece within a workpiece receiving space defined by said loop,
wherein said loop has a second end and between said second end and said free end said toothed band has an engaging portion at which said toothed surface engages said toothed drive wheel, and
wherein said engaging portion passes between said toothed drive wheel and a guide member that is mounted to said drive wheel mounting and configured such that at least four teeth of said toothed band are in engagement with said toothed drive wheel.

2. A strap wrench as claimed in claim 8, wherein said drive receiving element comprises a drive spigot provided on an end of said toothed drive wheel or an axially extending recess provided in an end of said toothed drive wheel.

3. A strap wrench as claimed in claim 1 or 2, wherein said drive wheel mounting comprises a first mounting plate and a second mounting plate disposed opposite and spaced apart from said first mounting plate and said toothed drive wheel extends between said first and second mounting plates.

4. A strap wrench as claimed in claim 3, wherein said toothed drive wheel rotatably engages in respective recesses or apertures provided in said first and second mounting plates.

5. A strap wrench as claimed in claim 4, wherein said toothed drive wheel has a first end provided with a first trunnion engaged in an aperture or recess in said first mounting plate and a second end provided with a second trunnion engaged in an aperture or recess in said second mounting plate.

6. A strap wrench as claimed in claim 3, 4 or 5, wherein said engaging portion of said toothed band is disposed between said first and second mounting plates and said first and second mounting plates have respective arcuate edges that face towards said workpiece receiving space.

7. A strap wrench as claimed in claims 6, wherein said arcuate edges are configured to define a plurality of teeth to engage a workpiece gripped in said workpiece receiving space.

8. A strap wrench as claimed in claim 6, wherein said arcuate edges are fitted with respective polymer grip enhancing strips.

9. A strap wrench as claimed in any one of the preceding claims, wherein said fixed portion of said toothed band is disposed between a first anchor member and a second member and at least one third anchor member, said first and second anchor members engaging said toothed side and said at least one third member engaging said non-toothed side such that said fixed portion is fixed between said first, second and third anchor portions.

10. A strap wrench as claimed in any one of the preceding claims, wherein said guide member is a rod.

11. A strap wrench as claimed in any one of the preceding claims, wherein said guide member is removably mounted to said drive wheel mounting.

12. An air suspension wrench 1, comprising, a drive unit 20 which includes a drive unit axle 30 with output drive cog 33 protrusions on its periphery and an input drive recess 32 within its centre, with trunnions 31 either end and incorporating circlip grooves 35 for retaining circlips 36 or the like, said drive axle trunnions 31 rotationally held within end plate axle bushes 401, the end plates 400 further retained in position by a spacer plate 50 having distancing shoulders 53 and secured by riveting portions 54 within the end plate spacer plate recesses 403, further creating a drive unit restricted passage 21 through which the cam belt free end 64 can pass, whereby when its incorporated cam belt cog protrusions 61 are fully engaged within the drive axle cog recesses 34, whereas the cam belt inner drive surface 65 is now capable of traversing against the spacer plate guide surface 51, further characterized by the fitment of a rotational pin 71 that is removable in order to fit the cam belt free end 64 and after fitment of said rotational pin 71 this ensures that at least four of the cam belt free end 64, cam belt cog protrusions 61 are engaged into the corresponding drive axle cog recesses 34 in order to distribute the applied drive torque DT over twice as many cam belt cog protrusions 61 as in the prior art, considerably reducing the incidence of wear or failure.

13. An air suspension wrench 1 as claimed in claim 12, characterised by being specifically for use with a used and now recycled cam belt 60 which is normally a discarded vehicle service item, cut to length for the particular purpose required, said cam belt 60 comprising a free end 64 and a retained end 63, fitted within the drive unit 20, they form the cam belt closed loop 66, said cam belts 60 normally utilizing a standardised ten millimetres cog pitch 67.

14. An air suspension wrench 1 as claimed in claim 13, wherein said cam belt fixed end 63, cam belt inner drive surface 65 is held as required between the spacer plate guide back surface 52 and a minimum of two known clevis pin type, locking pins 70 engaged within the cam belt cog recesses 62, said locking pins 70 retained within the end plate locking holes 402 by known R clips 72 or the like, the drive unit 20 is further characterized by said rotational pin 71, when installed in the end plates cam belt free end rotational pin bores 408, furthermore guiding the cam belt free end 64 around the drive axle output drive cogs 33, therefore forming a cam belt 60 closed loop 66, said closed loop 66 internal surface comprising the cam belt inner drive surface 65, the rotational pin 71 retained by known R clips 72 or the like, is capable of free rotation within said end plate cam belt free end rotational pin bores 408 as the action of the cam belt inner drive surface 65 traversing, propels it round.

15. An air suspension wrench 1 as claimed in claim 14, wherein said end plates 400 prevent in use said drive unit 20 swivelling inwards in the direction of the known drive 90 and the wrench further comprises an anti-swivel, end plate first and second ends 404, 405 within an elongate end plate curved contact surface 407 which further incorporates end plate gripping teeth 406.

16. An air suspension wrench 1 as claimed in in any one of claims 12 to 15, wherein said end plates 400 have no end plate gripping teeth 406, but even further characterized by a U-shaped rubber or similar, end plate curved contact gripping strip 410 held between end plate curved contact surface end stops 409 within the end plate first end and second ends 404, 405;

17. An air suspension wrench 1 as claimed in any one of claims 12 to 16, wherein said end plates second end 405 is even further characterized, by ensuring in use the cam belt fixed end 63 is kept generally parallel to the spacer plate guide back surface 52 and further ensuring said cam belt fixed end 63 is kept generally straight as it is drawn off the workpiece cylindrical surface 81 by the extension and correct orientation of the end plates second end 405, thereby drastically reducing unwanted component stress and the chance of locking pin 70 or cam belt 60 failure.

18. An air suspension wrench 1 as claimed in any one of claims 10 to 17, wherein, in use, when the rotational pin 71 is removed the cam belt free end 64 is then extremely easy to withdraw or replace into the drive unit restricted passage 21 allowing the cam belt free end 64 to be separately and conveniently threaded around the workpiece cylindrical surface 81 in constrained situations, before being reinstalled and the rotational pin 71 being replaced in a timely manner.
